(19) United States
(12) Patent Application Publication
(10) Pub. No.: US 2004/0195942 A1
(43) Pub. Date: Oct. 7, 2004

(54) Hidden door hinge for vending machine

(75) Inventor: Daniel S. Carter, Fresno, CA (US)

Correspondence Address: BAKER BOTTS, LLP, 910 LOUISIANA, HOUSTON, TX, 77002-4995, US

(73) Assignee: THE VENDO COMPANY

(21) Appl. No.: 10/404,614

(22) Filed: Apr. 1, 2003

(51) Int. Cl. E06B 1/00; A47F 3/00

(52) U.S. Cl. 312/139

(57) ABSTRACT

The present invention relates to a hidden door hinge that is hingedly coupled to an outer door of a vending machine for the purpose of securing the vending machine and to prevent theft and vandalism. The present invention prevents unauthorized access to the interior of a vending machine by providing a hinging system that is used to attach the outer door to the cabinet of the vending machine. The hinging system provides a hinge having a pivot that is supported by an arching member that allows a portion of the outer door to swing within the hinge itself. The outer door has a small cutout at the hinge area through which the hinge passes. The small cutout is covered by the cabinet and not accessible from outside the vending machine. Hinge pins allowing the hinge to pivot are located on the inside of the outer door. The door can be nestled in the cabinet to strengthen the cabinet frame and improve security for the vending machine.

### TECHNICAL FIELD OF THE INVENTION

This invention relates in general to the field of vending machines, and more particularly, to a system and method for securing a vending machine from theft and vandalism.

### BACKGROUND OF THE INVENTION

Vending machines are widely used to dispense beverages, food, and other perishable and nonperishable goods. Vending machines are often placed at unattended and isolated locations where they must not only withstand harsh elements from the weather and the environment, but also resist the damage inflicted upon them by thieves and vandals. Theft and vandalism directed toward vending machines pose significant problems for operators and manufacturers in the vending industry, and the prevention thereof is an important consideration in the operation of vending machines.

A typical vending machine is a housing, which may be a cabinet, with an outer door at the front that swings to open and close the housing. It is a common practice that the outer door is attached to the vending machine by the use of exterior top and bottom hinges. The top hinge is generally a heavy flat plate cantilevered from the housing over the top of the door. The lower hinge is rigidly attached to the base of the housing. Both top and bottom hinges have hinge pins that run along the axis of rotation of the door.

A common method for breaking into a vending machine that uses the existing hinging system is to defeat either the top or the bottom hinge. For existing vending machines, top hinges are commonly attached with carriage bolts to the outside of the vending machine cabinet. The heads of these bolts can be forcibly removed with an ordinary chisel, saw, or other hardware tools. After the exposed bolts are attacked, the hinges can be loosened or removed. Even if the hinges are only loosened, the hinge pins about which the hinge pivots can become exposed. Once exposed, the hinge pins can be cut with an ordinary hacksaw, file, or other cutting tools. All other exposed hinges on the vending machine are at risk and can be similarly attacked. After the hinges or pin hinges are forcibly severed, the outer door protecting the vending machine cabinet can be removed. Thus, the thief or vandal can gain access to the interior of the vending machine to steal large sums of cash.

In existing vending machines, the outer doors and hinges fail to prevent, or even deter, theft and vandalism. Existing vending machines are vulnerable because their exposed hinges and outer doors are obvious attack points. Their vulnerability is compounded by the fact that vending machines are typically operated in unattended and isolated areas, thereby often allowing sufficient time for thieves and vandals to break into the vending machines. To combat this type of theft and vandalism, existing vending machines have incorporated hinges and doors made of stronger metals in an attempt to resist break-ins. Other advances have included the use of improved locking mechanisms and electronic measures to counter theft and vandalism. Although these efforts have added significant costs to vending machines, they have not succeeded in eliminating the incidents of break-ins. Unfortunately, advances in some areas of protection for a vending machine have shifted the vandals' attention to other components of a vending machine that are less protected, such as the exposed hinges.

For vending machine operators, break-ins cause significant financial losses, which include loss of large sums of cash stored inside the vending machines, loss of vending products stored inside the machines, cost of repair or replacement of the damaged machines, and loss of sales revenues during the time that the machines are made inoperable by the break-ins.

Therefore, there is a strong and unmet need in the vending industry to provide vending machine designs that prevent theft and vandalism to vending machines.

### SUMMARY OF THE INVENTION

It is an object of the present invention to provide an improved method and apparatus for preventing unauthorized access to the interior of a vending machine.

Another object of the present invention is to provide such a method and apparatus that enclose the hinging system inside the outer door and cabinet of the vending machine, thus shielding the hinging system from outside view.

Another object of the present invention is to provide such a method and apparatus that reduce the incidence of vandal attacks and break-in potential of the vending machine while strengthening overall construction of the outer door and cabinet of the vending machine.

Another object of the present invention is to provide such a method and apparatus that secure the outer door to the cabinet by stepping part of the outer door and allowing it to nestle inside the cabinet of the vending machine, thus strengthening the cabinet frame and preventing cabinet deflection.

Another object of the present invention is to provide such a method and apparatus that allow full access to cabinet contents with a 90 degree minimum angle for opening the inner door to the interior.

Another object of the present invention is to provide such a method and apparatus that is adaptable for use with commonly available locking mechanisms.

Another object of the present invention is to provide such a method and apparatus that allow for more efficient installation of the outer door assembly during both manufacturing and field service.

A further object of the present invention is to provide such a method and apparatus that improve the aesthetics of the vending machine by shielding the hinging system from outside view.

Thus, the present invention achieves these objects in a method and apparatus for preventing unauthorized access to the interior of a vending machine. The apparatus includes a hinging system attached to an outer door and cabinet of a vending machine. The hinging system provides a hinge having a pivot that is supported by an arching member that allows a portion of the outer door to swing within the hinge itself. The outer door has a small cutout at the hinge area through which the hinge passes. The small cutout is covered by the cabinet and not accessible from outside the vending machine. Hinge pins allowing the hinge to pivot are located on the inside of the outer door. The door can be nestled in the cabinet to strengthen the cabinet frame and improve security for the vending machine. The door is adaptable to accommodate common locking systems, such as “T” handle type screw locks and three-point locking systems.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a view of a vending machine that uses a common, existing hinging system.

FIG. 2 is a view of a vending machine that uses the hinging system of the present invention.

FIG. 3 is a detailed view of a vending machine that uses the hinging system of the present invention.

FIG. 4 is a view of two exemplary embodiments of the hidden hinge of the present invention.

FIG. 5 is a view of a vending machine that uses a common, existing hinging system.

FIG. 6 is a view of the upper and lower hinge supports of an existing hinging system.

FIG. 7 is a detailed view of a vending machine that uses the hinging system of the present invention.

### DETAILED DESCRIPTION OF THE INVENTION

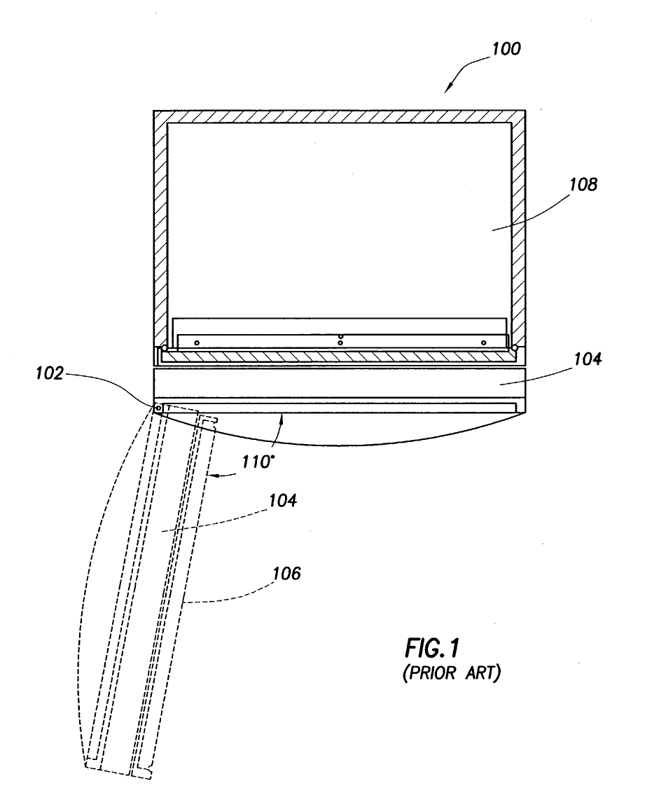

FIG. 1 shows a vending machine 100 that uses a common, existing hinging system. Vending machine 100 has an outer door 104 and an inner door 106. The existing hinging system typically includes hinges 102, at the left front corner of outer door 104. Inner door 106 encloses the refrigerated cabinet 108 of the vending machine. A disadvantage of this design is that hinges 102 are exposed to outside view and are accessible from the outside of vending machine 100. As such, the hinges 102 are at risk for vandal attacks and break-ins.

Another significant disadvantage of this design is that, when the inner door 106 is opened, for example, to about 110 degrees as shown in FIG. 1, access to the left inside of the machine is limited. In order to provide more access to the left inside of the machine, inner door 106 must be opened to a much wider angle, which requires that outer door 104 also be opened to a wider angle. The requirement for a wider angle is not a desirable feature. When in use, a vending machine is often positioned with other vending machines, typically side by side in a row. Vending machines are also often positioned in a corner with a left wall, that is, where the left wall faces the right side of a vending machine. In these common arrangements, there is very limited space between the exterior side of one machine and that of its neighbor or the left wall, which results in very little space available for opening the outer door 104. The current design shown in FIG. 1 requires that outer door 104 be opened to a much wider angle in order to gain full access to the refrigerated cabinet 108. While it is desirable to provide full access to the refrigerated cabinet 108 of a vending machine, it is a disadvantage of the design to achieve this access by opening the outer door 104 to a much wider angle.

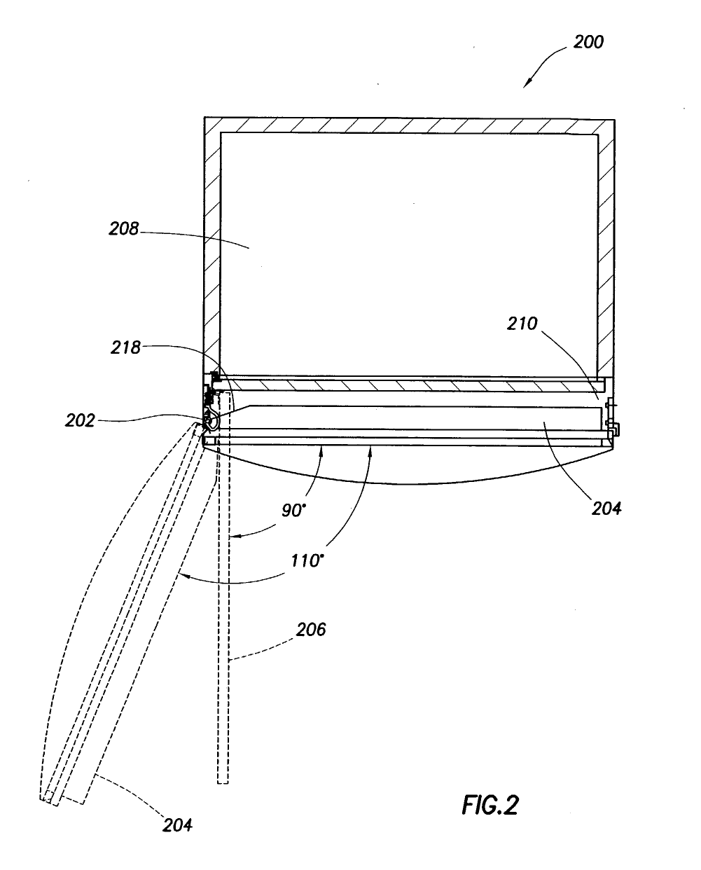

FIG. 2 shows a vending machine 200 that uses the hinging system of the present invention. Vending machine 200 has an outer door 204 and an inner door 206. The existing hinging system includes hinges 202 at the left front corner of outer door 204. However, unlike that of FIG. 1, hinges 202 are operable to be hidden from view and access when outer door 204 is closed. Further, the sloped profile 218 of outer door 204 is reduced to allow inner door 206 to be opened without requiring that outer door 204 be opened to an excessive angle. As shown in the embodiment of FIG. 2, when outer door is opened to about 110 degrees, inner door 206 can be opened to about 90 degrees, which allows the refrigerated cabinet 208 to be fully accessible.

As shown in FIG. 2, when outer door 204 is closed, hinges 202 are shielded from view and are not accessible from the outside of vending machine 200, and thus cannot be used as a break-in point of attack. Further, when outer door 204 is in the closed position, the top side of outer door 204, the right side of outer door 204, and the left side of outer door 204 are stepped in, such that the sides nestle inside cabinet frame 210 of vending machine 200. Thus, the top side, right side, and left side of outer door 204 are not exposed and cannot be used as a break-in point. Nestling these sides inside cabinet frame 210 has the effect of strengthening cabinet frame 210, preventing frame deflection, and increasing overall security for vending machine 200.

The door and hinging system of present invention can be used with any locking mechanism suitable for locking the outer door 204 to the cabinet frame 210. Such locking mechanisms include, for example, a screw-type locking system, a multi-point latch system, a keyless system, or any other common locking system.

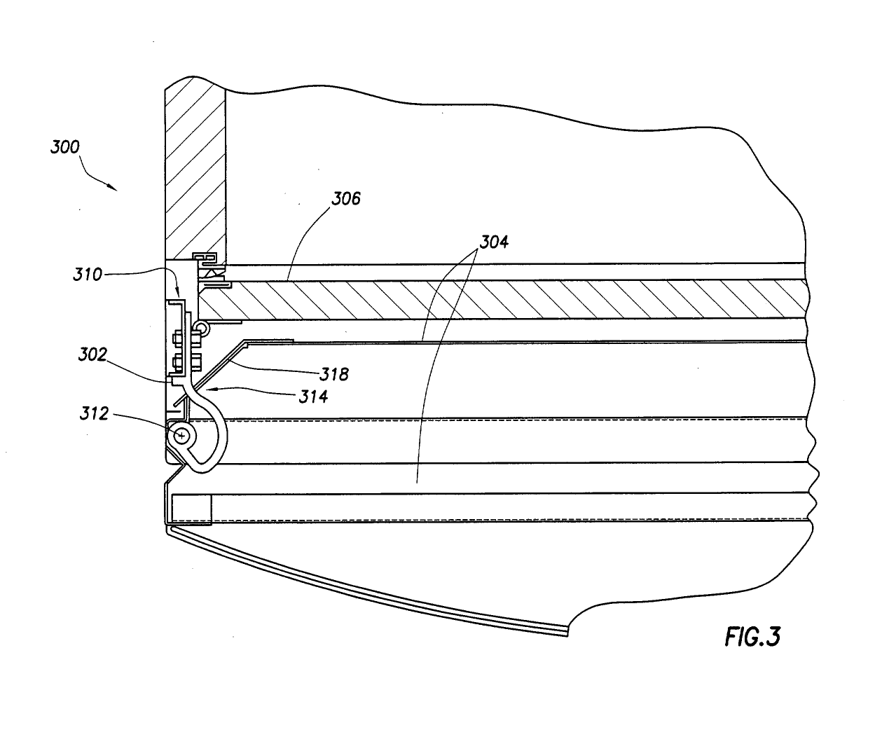

FIG. 3 shows an embodiment of the present invention, wherein one end of hidden hinge 302 is attached to outer door 304 and a second end of hidden hinge 302 is attached to the cabinet frame 310 of vending machine 300. Hinge 302 has a pivot 312 that is supported by an arching member that allows a portion of outer door 304 to swing within hidden hinge 302 itself. Outer door 304 has a small cutout 314 at the hinge area through which hidden hinge 302 passes. Viewed from the outside of the vending machine 300, the small cutout 314 is covered by the cabinet 310 and is not accessible. A hinge pin located on the inside of outer door 304 at pivot 312 allows hidden hinge 302 to pivot, enabling outer door 304 to swing open and close. Outer door 304 is nestled in cabinet 310, which strengthens the cabinet frame 310 and further improves security for the vending machine 300. A sloped profile 318 of outer door 304 allows inner door 306 to be opened without requiring that outer door 304 be opened to an excessive angle. As shown in the embodiment of FIG. 3, the angle of sloped profile 318 may be modified as needed in order to allow full access to cabinet 310 and minimize the opening angle of outer door 304.

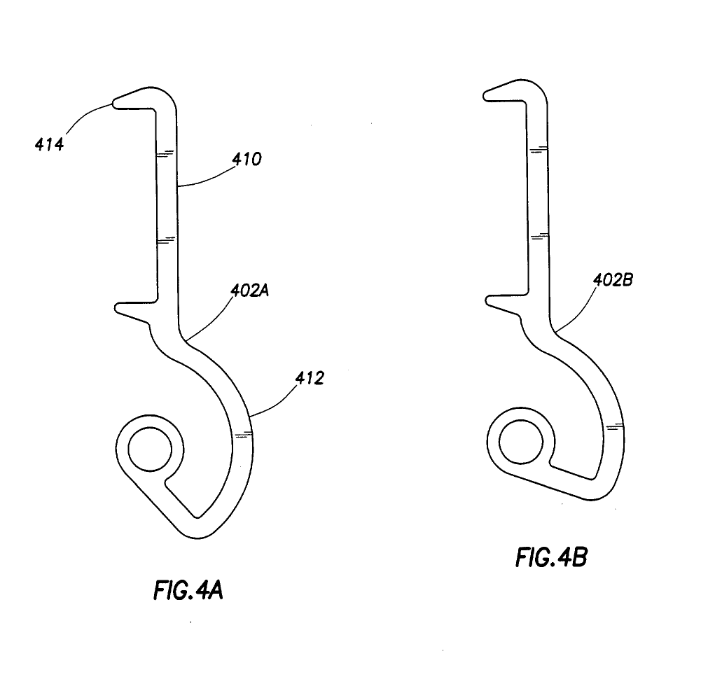

FIG. 4A and 4B depict two exemplary embodiments of hidden hinges, 402A and 402B. Other embodiments may be derived by modifying various parts of the hidden hinge, for example, the length and depth 410 of the hinge, the angle of the arching member 412, and the number of attachment points 414 that connect the door to the cabinet.

FIG. 5 depicts a vending machine 500 that uses existing support hinges. Cabinet 508 is enclosed by outer door 504. Outer door 504 is attached to cabinet 508 by upper hinge plate 512 and lower hinge plate 514. Both hinge plates 512 and 514 are exposed and vulnerable to vandal attacks. Upper hinge 512 is commonly attached with carriage bolts 516 to the outside of the vending machine cabinet 508. The heads of carriage bolts 516 can be forcibly removed with an ordinary chisel, saw, or other hardware tools. After the exposed bolts 516 are attacked, upper hinge 512 can be loosened or removed. Even if hinge 512 is only loosened, hinge pin 518 about which upper hinge 512 pivots can become exposed. Once exposed, hinge pin 518 can be cut with an ordinary hacksaw, file, or other cutting tools. All other exposed hinges, such as lower hinge plate 514, and hinge pins, such as lower hinge pin 528, on the vending machine are at risk and can be similarly attacked. After upper hinge 512 is forcibly severed, outer door 504 protecting the vending machine cabinet can be removed. Thus, the thief or vandal can gain access to the interior of vending machine 500 to steal large sums of cash and other contents.

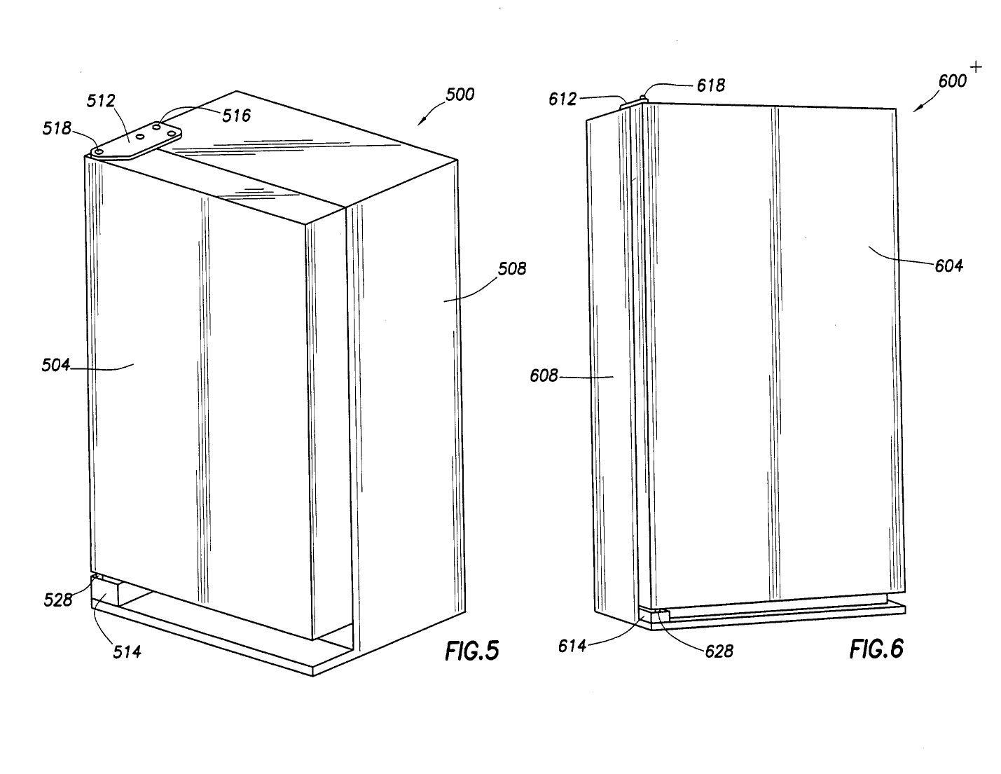

FIG. 6 provides another view of the exposed hinge plates 612 and 614 found in existing vending machine 600 that are vulnerable to attacks. Hinge plates 612 and 614 attach outer door 604 to cabinet 608. When upper hinge 612 and lower hinge 614 are loosened or severed, hinge pins 618 and 628 can become exposed and vulnerable to attack.

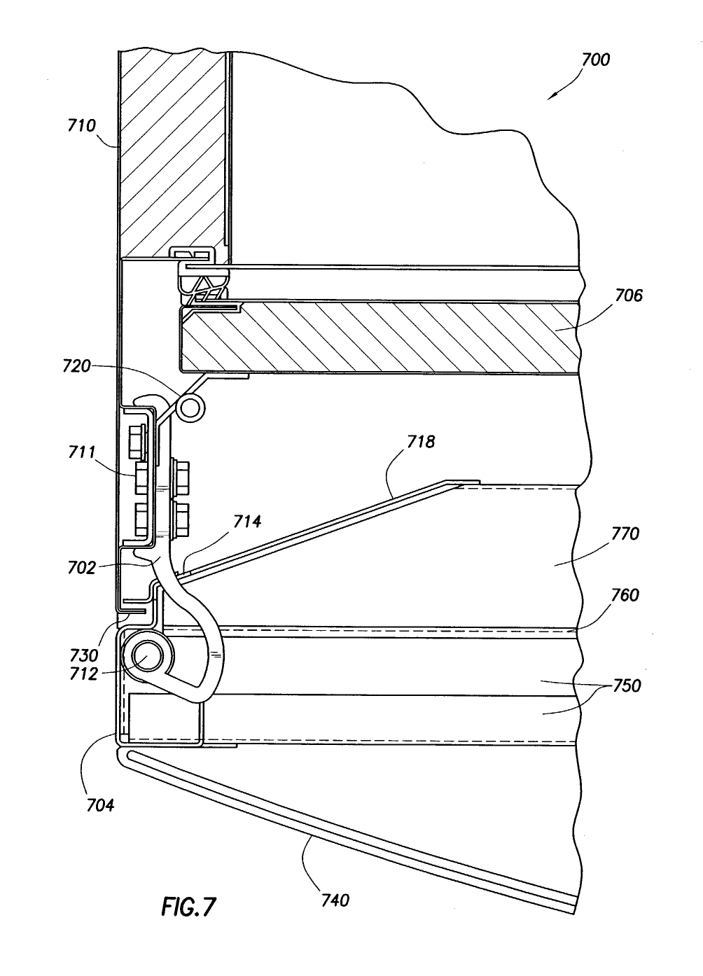

FIG. 7 shows an embodiment of the present invention similar to FIG. 3 but in greater details, wherein one end of hidden hinge 702 is attached to outer door 704 and a second end of hidden hinge 704 is attached at attachment point 711 to the cabinet frame 710 of vending machine 700. Attachment 711 is made by carriage bolts to secure one end of hidden hinge 702 to cabinet frame 710. Hinge 702 has a pivot 712 that is supported by an arching member that allows a portion of outer door 704 to swing within hidden hinge 702 itself. Outer door 704 has a small cutout 714 at the hinge area through which hidden hinge 702 passes. Viewed from the outside of the vending machine 700, the small cutout 714 is covered by the cabinet 710 and is not accessible. A hinge pin at pivot 712 located on the inside of outer door 704 allows hidden hinge 702 to pivot, enabling outer door 704 to swing open and close. Outer door 704 is nestled in cabinet 710, which strengthens the cabinet frame 710 and further improves security for the vending machine 700. A sloped profile 718 of outer door 704 allows inner door 706 to be opened without requiring that outer door 704 be opened to an excessive angle. Inner door 706 is attached to cabinet 710 by inner door hinge 720. The front edge of cabinet frame 710 is depicted at 730. The portion of outer door 704 that is stepped in such that the sides of outer door 704 nestle inside cabinet frame 710 is shown at 770. Thus, the top side, right side, and left side of outer door 704 are not exposed and cannot be used as a break-in point. The portion of outer door 704 that is exposed to outside view is shown at 750. The stepped in portion of door 704 is begins at 760. Sign face 740 is attached to outer door 704 and is used to display products sold in vending machine 700.

In other embodiments of the present invention, but not shown by the drawings herein, a protective guard can be added to the outside of the vending machine at the location where the hidden hinges are located within the cabinet and outer door.

In another embodiment, the length of the hidden hinge can be altered to provide more enhanced security to the hinging system and the vending machine.

In any of its embodiments, the hidden hinge can be manufactured by many methods, such as those involving powder metal process, stamped metal, extrusion, or the like.

In another embodiment, the hidden hinge can be used in combination with a plurality of one or more hidden hinges to secure the outer door.

In another embodiment, the hidden hinge can be used in combination with a plurality of one or more existing exposed hinges, wherein the hidden hinge may be located either above or below the one or more of the exposed hinges.

What is claimed is:

1. A vending machine, comprising:
a housing for storing vending products;
an outer door hingedly coupled to the housing, the outer door capable of swinging to an open position and a close position; and
a hinging system for coupling the outer door to the housing, the hinging system comprising a hidden hinge having a first end attached to the outer door and a second end attached to the housing, the first and second ends being positioned inside the housing and outer door such that the hidden hinge is not accessible from the outside of the vending machine when the outer door is at the close position.

2. The vending machine according to claim 1, wherein the outer door has a cutout opening through which the hidden hinge passes when the outer door swings, wherein the cutout opening is covered by the housing and not accessible from outside the vending machine when the outer door is at the close position.

3. The vending machine according to claim 2, wherein the hidden hinge has a pivot that is supported by an arching member that allows the cutout opening of the outer door to swing within the hidden hinge itself.

4. The vending machine according to claim 3, wherein the hinging system further comprises an exposed hinge to be used in combination with the hidden hinge for coupling the outer door to the housing, such that the exposed hinge is accessible, while the hidden hinge is not accessible, from the outside of the vending machine when the outer door is at the close position.

5. The vending machine according to claim 4, wherein the hinging system further comprises a plurality of hidden hinges for coupling the outer door to the housing.

6. The vending machine according to claim 5, wherein the hinging system further comprises a plurality of exposed hinges for coupling the outer door to the housing

7. The vending machine according to claim 6, wherein one of the plurality of hidden hinges is located below one of the plurality of exposed hinges.

8. The vending machine according to claim 6, wherein one of the plurality of hidden hinges is located above one of the plurality of exposed hinges.

9. The vending machine according to claim 8, further comprising a plurality of protective guards covering the housing and outer door at the positions where the plurality of hidden hinges are located.

10. The vending machine according to claim 9, wherein the outer door has a top edge, a first side edge, and a second side edge, wherein the top edge, the first side edge, and the second side edge can be nestled inside the housing when the outer door is closed.

11. The vending machine according to claim 10, wherein the outer door has a sloped profile that allows an inner door to be opened to allow full access to the interior of the housing.

12. The vending machine according to claim 11, wherein the outer door is suitable for use with a common locking mechanism to secure the outer door to the housing.

13. The method for securing a vending machine, comprising the steps of:
storing vending products in a housing;
providing an outer door to be hingedly coupled to the housing, the outer door capable of swinging to an open position and a close position; and
coupling the outer door to the housing by using a hinging system, the hinging system comprising a hidden hinge having a first end attached to the outer door and a second end attached to the housing, the first and second ends being positioned inside the housing and outer door such that the hidden hinge is not accessible from the outside of the vending machine when the outer door is at the close position.

14. The method according to claim 13, wherein the outer door has a cutout opening through which the hidden hinge passes when the outer door swings, wherein the cutout opening is covered by the housing and not accessible from outside the vending machine when the outer door is at the close position.

15. The method according to claim 14, wherein the hidden hinge has a pivot that is supported by an arching member that allows the cutout opening of the outer door to swing within the hidden hinge itself.

16. The method according to claim 15, wherein the hinging system further comprises an exposed hinge to be used in combination with the hidden hinge for coupling the outer door to the housing, such that the exposed hinge is accessible, while the hidden hinge is not accessible, from the outside of the vending machine when the outer door is at the close position.

17. The method according to claim 16, wherein the hinging system further comprises a plurality of hidden hinges for coupling the outer door to the housing.

18. The method according to claim 17, wherein the hinging system further comprises a plurality of exposed hinges for coupling the outer door to the housing

19. The method according to claim 18, wherein one of the plurality of hidden hinges is located below one of the plurality of exposed hinges.

20. The method according to claim 18, wherein one of the plurality of hidden hinges is located above one of the plurality of exposed hinges.

21. The method according to claim 20, further providing the step of covering the housing and the outer door at the positions where the plurality of hidden hinges are located with a plurality of protective guards.

22. The method according to claim 21, wherein the outer door has a top edge, a first side edge, and a second side edge, wherein the top edge, the first side edge, and the second side edge can be nestled inside the housing when the outer door is closed.

23. The method according to claim 22, wherein the outer door has a sloped profile that allows an inner door to be opened to allow full access to the interior of the housing.

24. The method according to claim 23, wherein the outer door is suitable for use with a common locking mechanism to secure the outer door to the housing.
